(19) United States
(12) Patent Application Publication
(10) Pub. No.: US 2009/0302799 A1
(43) Pub. Date: Dec. 10, 2009

(54) Case for Recharging an Electronic Apparatus in a Mobility Situation

(76) Inventors: Didier Marquet, Issy Les Moulineaux (FR); Michel Vernet, Issy Les Moulineaux (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/086,955

(22) PCT Filed: Dec. 19, 2006
(86) PCT No.: PCT/FR2006/051381

§ 371 Date: Jul. 10, 2009

(30) Foreign Application Priority Data
Dec. 19, 2005 (FR) 0512878

(51) Int. Cl. H01M 10/46; H02J 7/00

(52) U.S. Cl. 320/101; 320/108

(57) ABSTRACT

A casing (20A, 20B) can contain at least one apparatus (10) including a battery (12). The casing includes connection means (22) adapted to a connector (11) of said apparatus (10). The casing (20A, 20B) can be placed in a case (30) including energy storage means (32). The case (30) includes wireless means (35) adapted to transmit energy to wireless means (25) of the casing (20A, 20B) that are adapted to receive the energy. The case (30) includes holder means (37) for holding the casing (20A, 20B) in at least one predetermined position while mobile.

### BACKGROUND OF THE INVENTION

The field of the invention is that of an electrical or electronic apparatus including a battery.

In this specification, the term “battery” is used generically to designate one or more electrochemical storage cells arranged in series or in parallel.

More precisely, the present invention seeks to enable such batteries to be recharged in order to increase the endurance of portable apparatus while mobile. In non-limiting manner, the invention thus makes it possible to recharge the battery of a cell phone, of a personal organizer, or of an earpiece.

In known manner, portable apparatus are conventionally recharged by a mains adapter suitable for delivering a low direct current (DC) voltage thereto via a cable terminated by a connector, or by a recharging port placed on a desk. The voltage may also come from an electric cable connected to a car cigar lighter.

The invention is more particularly for use by users in locations where those conventional sources are not available.

Document WO 00/07277 describes a device for recharging cell phone batteries, in particular when in a zone that lacks a source of electricity, in particular at sea.

That recharger device uses wireless means for delivering energy to the cell phone by a vibratory, electromagnetic, or electromechanical effect, by an inertial effect, or by a clockwork mechanism.

Unfortunately, those various solutions require a special arrangement in the cell phone, and in particular, it must necessarily include means for receiving the energy produced by the recharger device.

### OBJECT AND SUMMARY OF THE INVENTION

A main object of the present invention is thus to remedy the above-mentioned drawbacks by proposing a solution enabling the battery of an electrical or an electronic apparatus to be recharged in particular when mobile, and without modifying the apparatus.

Thus, in a first aspect, the invention provides a case adapted to contain at least one casing suitable for containing at least part of at least one apparatus having a battery, the casing comprising:
wireless means for receiving energy from another piece of equipment; and
connection means matching a connector of said apparatus in order to feed said battery with energy received from said other piece of equipment.

The casing may be constituted by a rigid or semirigid shell or by a flexible cover. It may enclose the apparatus completely, or cover it in part.

In accordance with the invention, the electrical apparatus does not require any modification, since it is connected to the casing by means of the connector that is provided for recharging its battery by means of an adapter connected to the mains.

In the most common mode of use, the electronic apparatus is inserted once and for all in the casing, with the connection means of the casing being connected to the above-mentioned connector.

Naturally, the electronic apparatus can be removed from the casing should that be necessary, e.g. for the purpose of making a repair.

In any event, the battery of the electronic apparatus is fed from energy received wirelessly from some other piece of equipment, that equipment also being in accordance with the invention.

In a second aspect, the invention provides a case adapted to contain at least one article, the case comprising:
energy storage means;
wireless means adapted to transmit energy to said casing; and
holder means for holding said casing in at least one predetermined position while mobile.

In a particular embodiment, the casing in accordance with the invention constitutes said article. Thus, the case of the invention transmits energy wirelessly to the casing, which then supplies it to at least one electronic apparatus it contains via its connection means.

The case may be constituted in particular by a pouch, a compartment in a bag, or a pocket in a garment.

In a particular embodiment, the casing includes a solar cell adapted to recharge the battery of the electronic apparatus via its connector. This characteristic enables the electrical apparatus to be recharged without the case.

In accordance with the invention, it is essential for the wireless means of the casing for receiving energy to be positioned to receive the energy transmitted by the wireless means of the case.

That is why the case includes holder means for holding the article, and in particular the casing, in at least one predetermined position while mobile.

For example, these holder means may include guide means adapted to the shape of the article they contain, i.e. the casing of the invention, for example.

These holder means may include at least one magnet.

In a particular embodiment, the casing also contains means enabling it to be fastened to the equipment supplying it with energy, i.e. the case of the invention, for example, in at least one predetermined position while mobile.

These fastener means may be constituted, for example, by a piece of iron or at least one magnet adapted to co-operate with a magnet of the case.

The energy storage means of the case may be of various types and may be constituted in particular by a primary cell, a fuel cell, a capacitor, or a storage battery.

In a particular embodiment, the energy storage means of the case are of a kind different from the battery of the electronic apparatus. These storage means may for example be capable of recharging more rapidly than the battery of the electronic apparatus or under conditions that are different, for example in terms of temperature or lifetime. The battery of the case may be constituted by NiCd or NiMH storage cells.

The energy storage means of the case may be recharged by any means, e.g. by solar energy or by means of a connector connected to an electricity mains outlet.

In a particular embodiment, the casing also includes a battery that is adapted to feed the battery of the electronic apparatus contained in the casing via its connector.

In a particular embodiment, this casing battery is recharged by a solar cell of the casing.

It is necessary for the energy that is received by the electronic apparatus to comply with its electrical requirements.

Consequently, in a particular embodiment, the case includes means for adapting the energy transmitted to the article, and in particular the casing, as a function of the electrical constraints of the article or of an electronic apparatus contained in the article.

Similarly, in a particular embodiment, the casing includes energy-adaptation means for adapting the energy received from the equipment supplying said energy, e.g. the case, as a function of the electrical constraints of the apparatus it contains, or of the battery of said apparatus.

In particular, the energy adaptation means of the casing may comprise a polarization rectifier adapted to generate electricity of polarity that is compatible with the polarity of the connector of the electronic apparatus.

In a particular embodiment, the casing includes protection means adapted to avoid discharging or overcharging the battery of the electronic apparatus it contains.

In a particular embodiment, the case includes means for detecting the presence of the article it contains, and in particular the casing, and means for controlling its own wireless energy transmission means as a function of the presence or the absence of the above-mentioned article.

In a particular embodiment, the case includes means for determining the energy level in the article it contains, and in particular the casing or the electronic apparatus contained in the casing, and means for controlling its energy transmission means as a function of said level.

All types of wireless means may be used for transferring energy from the case to the article it contains, and in particular the casing of the invention.

In a particular embodiment, the wireless transmission means of the case are positioned so as to co-operate with wireless receiver means of the article it contains, e.g. the casing of the invention, in a plurality of positions of said article in the case.

In a particular embodiment, the wireless energy-receiver means of the casing and the wireless energy-transmitter means of the case comprise at least one surface contact.

As mentioned above, these surface contacts may be positioned on a plurality of surfaces of the case and/or of the casing so that the casing can be positioned any way round in the case.

In another particular embodiment of the invention, the wireless energy-receiver means of the casing include at least one secondary induction coil adapted to receive energy from a primary induction coil of the case.

In another particular embodiment of the invention, the wireless energy-receiver means of the casing include a photovoltaic receiver adapted to receiver energy from a light source of the case.

In an another embodiment of the invention, the wireless energy-receiver means of the casing comprise a roller adapted to drive a dynamo, the roller being driven by at least one roller of the case.

In all of these embodiments, the wireless energy-receiver means of the casing and the wireless energy-transmitter means of the case can be positioned on a plurality of faces of the casing and/or the case, so that energy transfer can be performed in a predetermined plurality of positions of the casing relative to the case, these predetermined positions being ensured by the holder means of the case, and optionally by fastener means of the casing.

In a preferred embodiment, the casing contains a plurality of battery-powered electronic apparatus, for example a cell phone and a wireless earpiece.

### BRIEF DESCRIPTION OF THE DRAWINGS

Other characteristics and advantages of the present invention appear from the following description made with reference to the accompanying drawings that show an embodiment having no limiting character. In the figures:

FIG. 1 shows a cell phone, a casing, and a case in accordance with a particular embodiment of the invention;

FIG. 2 shows the elements of FIG. 1, the cell phone being inserted in the casing;

FIG. 3 shows the elements of FIG. 1, the cell phone being inserted in its casing, the casing itself being inserted in the case;

FIG. 4 is a longitudinal section view of the FIG. 3 arrangement; and

FIGS. 5 and 6 are diagrams showing wireless energy-transmitter means and wireless energy-receiver means respectively of a case and of a casing in two embodiments of the invention.

### DETAILED DESCRIPTION OF EMBODIMENTS

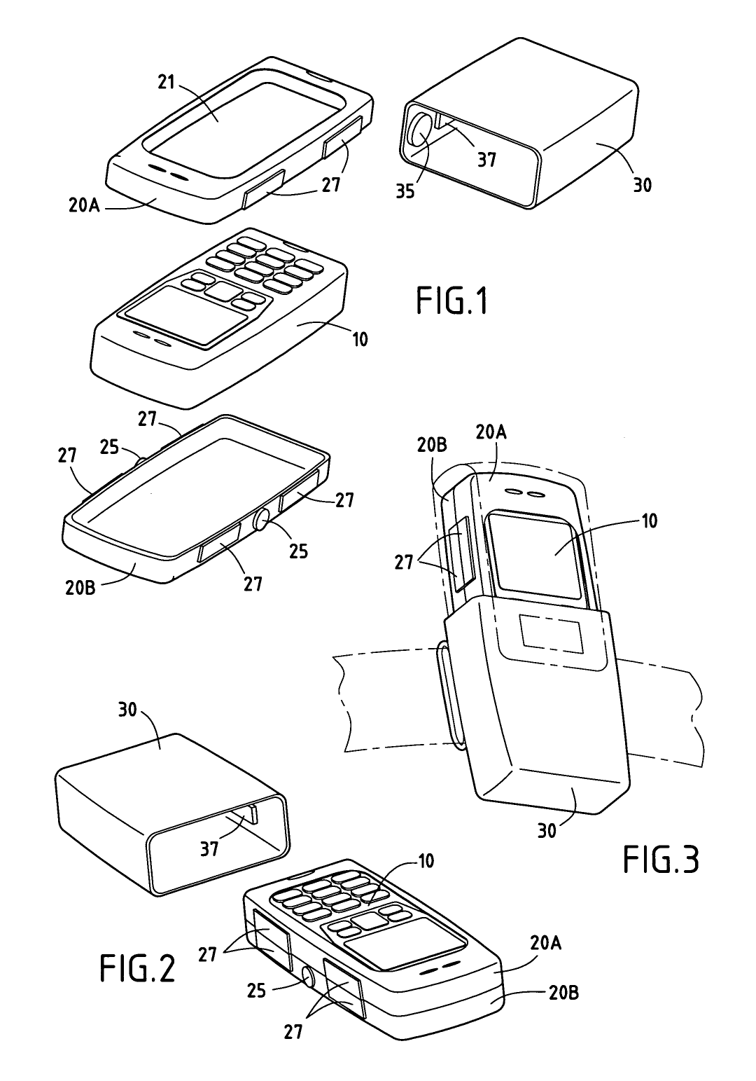

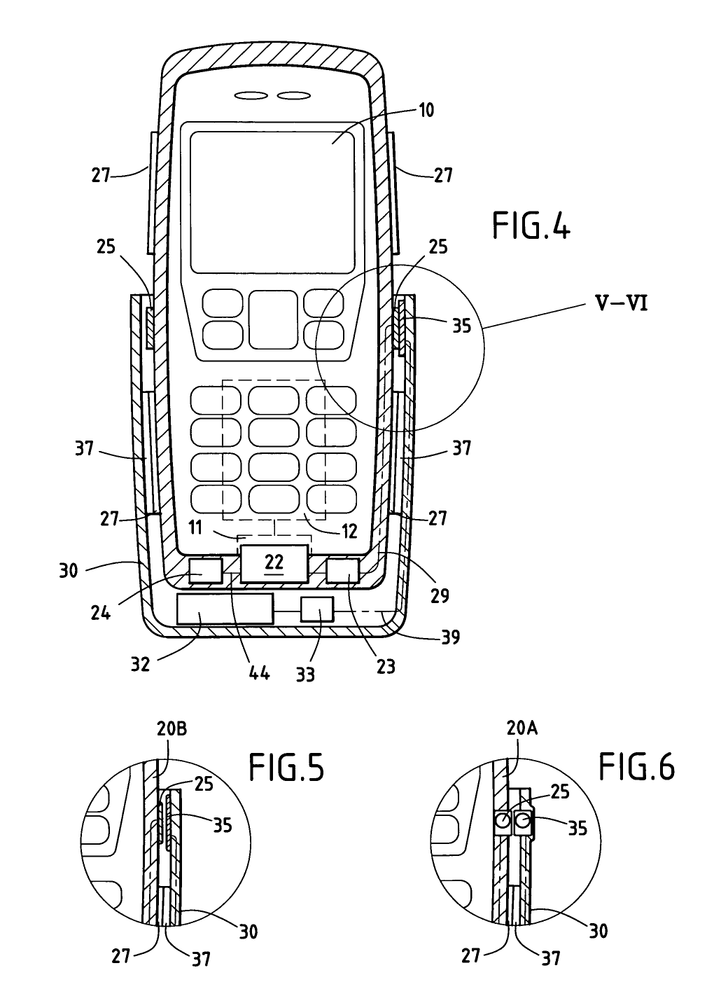

In FIG. 1, a cell phone is referenced 10. In conventional manner, the cell phone 10 includes a battery 12 and a connector 11 connected to the battery 12, these elements being shown in FIG. 4.

The connector 11 is adapted to receive an electric cable from a charger as conventionally sold with the cell phone 10, the charger being connected in known manner to the electricity network or to a car cigar lighter.

The connector 11 can also be adapted to co-operate with electrical terminations of a desk station connected to the electricity network.

In FIG. 1, references 20A and 20B designate the two portions of a casing in accordance with the invention. As shown in FIG. 2, the casing is adapted to contain the cell phone 10. In this example, a window 21 is provided in the top portion 20A of the casing so as to enable the keypad of the portable apparatus 10 to be operated.

In other variant embodiments, the casing may be made of flexible material, in the form of a film or a housing in which the cell phone 10 can be inserted.

Preferably, and as in the example described herein, the casing 20 is of a shape that matches the shape of the apparatus it contains.

As shown in FIG. 4, the casing 20A, 20B of the invention includes connection means 22 matching the connector 11 of the cell phone 10.

These connection means 22 may be wire connection means or they may be means of the type that is to be found in desk stations, terminated by electrical connections.

In any event, it is essential for the connection established between the connection means 22 of the casing and the connector 11 of the cell phone 10 to be maintained while mobile, i.e. while on the move.

In practice, the user of the cell phone 10 inserts the connection means 22 in the connector 11 of the portable apparatus 10 once and for all, and then encloses the cell phone 10 in the casing 20A, 20B.

In accordance with the invention, the casing 20A, 20B includes wireless means 25 for receiving energy from another piece of equipment 30.

In the preferred embodiment described herein, this other piece of equipment 30 is constituted by a case 30 in accordance with the invention.

In the embodiment shown in FIG. 3, the case 30 is constituted by a pouch suitable for being worn on a belt.

The case 30 in accordance with the invention includes means 32 for storing energy.

In the example described, these means 32 are constituted by a battery.

In a variant, they could be constituted in particular by a capacitor or by a primary cell or by a fuel cell.

In accordance with the invention, the case 30 includes wireless means 35 adapted to transmit energy to the article it contains, namely the casing 20A, 20B in the example described.

The energy transmitted by the wireless means 35 is obtained via a wire 39 from the storage means 32.

The wireless energy-receiver means 25 of the casing 20A, 20B are adapted to receive the energy transmitted by the wireless energy-transmitter means 35 of the case 30. For this purpose, it is important for the energy-receiver means 25 of the casing 20A, 20B and the energy-transmitter means 35 of the case 30 to be held facing each other when the casing 20A, 20B is placed and held in the case 30.

In the particular embodiment of the invention described herein, it is desirable for it to be possible for the casing 20A, 20B to be capable of being placed and held in the case 30 in a plurality of positions.

For this purpose, in the particular embodiment described, the wireless energy-receiver means 25 are placed on either side of the casing 20B such that at least one of them faces wireless energy-transmitter means 35 of the case 30, regardless of the position of the casing 20A, 20B in the case.

In the embodiment of FIG. 1, the wireless energy-transmitter means 35 of the case 30 and the wireless energy-receiver means 25 of the casing 20A, 20B are constituted by surface contacts.

When the wireless energy-receiver means 25 of the casing 20A, 20B receive energy from the case 30, this energy is transmitted via a wire 29 (shown in FIG. 4) to the battery 12 of the cell phone 10 via the connection means 22 of the casing that are inserted in the connector 11 of the telephone.

In the embodiment of FIG. 5, the wireless energy-receiver means 25 of the casing 20A, 20B and the wireless energy-transmitter means 35 of the case 30 are constituted respectively by a primary induction coil and by a secondary induction coil.

In the embodiment of FIG. 6, the wireless energy-receiver means 25 of the casing 20A, 20B and the wireless energy-transmitter means 35 of the case are constituted by rollers adapted to drive a dynamo of the casing 20A, 20B (not shown in the Figures).

In the particular embodiment of the invention described herein, the casing 20A, 20B of the invention includes an electronic circuit 23 for adapting the energy received from the case 30 as a function of the electrical constraints of the battery 12 of the apparatus 10.

More particularly, the electronic circuit 23 includes a polarization rectifier that delivers electricity with polarity that is compatible with the polarity of the connector 11 of the cell phone 10.

This electronic circuit 23 serves to avoid the battery 12 of the apparatus 10 discharging or overcharging.

In the embodiment described, the case 30 also includes an electronic circuit 33 for adapting the energy transmitted to the article it contains as a function of electrical constraints concerning that article or an apparatus contained therein.

In the embodiment described, the electronic circuit 33 of the case 30 is adapted to detect the presence of the casing 20A, 20B and to control the wireless energy-transmitter means 35 as a function of said presence.

This makes it possible to avoid pointlessly discharging the energy storage means 32 of the case 30.

More particularly, in the embodiment described here, the electronic circuit 23 is adapted to determine the level of energy available in the cell phone 10 and to control the wireless energy-transmitter means 35 so that they operate only when said level drops below a predetermined threshold.

In accordance with the invention, it is important for the wireless energy-receiver means 25 of the casing 20A, 20B and the wireless energy-transmitter means 35 of the case 30 to face one another while mobile.

For this purpose, the case 30 and/or the casing 20A, 20B includes means serving to guarantee such relative positioning.

For this purpose, in the example described, the casing 20A, 20B and the case 30 include respective magnetic portions 27, 37 enabling the casing to be positioned and held in the case in such a manner that the wireless communication means 25, 35 face each other.

As shown in FIG. 4, the casing 20A, 20B includes a plurality of magnets 27 so that it can be positioned any way round in the case 30.

In a variant, positioning of the casing 20A, 20B in the case 30 is guaranteed by means of the case 30 that are adapted to guide the casing 20A, 20B in such a manner that the wireless communication means 25 of the casing 20A, 20B and 35 of the case 30 are held facing each other including while mobile.

In the particular embodiment described with reference to FIG. 4, the casing 20A, 20B also includes a battery 24 adapted to feeding the battery 12 of the cell phone 10 via its connector 11.

For this purpose, the casing 20A, 20B includes an electric wire 44 connecting its battery 24 to its connection means 22.

In the embodiment described, the casing 20A, 20B also includes a solar cell (not shown) adapted to recharge both the battery 24 of the casing and the battery 12 of the cell phone 10 via the connector 11.

The batteries 12 and 24 of the cell phone and of the casing can optionally be charged simultaneously.

In the embodiment described, the casing 20A, 20B contains only one electronic apparatus, i.e. the cell phone 10.

In a variant, it could contain a plurality of electronic apparatus, and in particular an earpiece for use in combination with the cell phone 10.

1. A case (30) adapted to contain at least one casing (20A, 20B) suitable for containing at least part of at least one apparatus (10) having a battery (12), the casing (20A, 20B) comprising:
wireless means (25) for receiving energy from another piece of equipment (30); and
connection means (22) matching a connector (11) of said apparatus in order to feed said battery (12) with energy received from said other piece of equipment (30);
said case (30) comprising:
energy storage means (32);
wireless means (35) adapted to transmit energy to said casing (20A, 20B); and
holder means (37) for holding said casing (20A, 20B) in at least one predetermined position while mobile.

2. The case according to claim 1, wherein said energy storage means (32) are selected from:
a primary cell or a fuel cell;
a capacitor; and
a rechargeable battery.

3. The case according to claim 1 comprising means (35) to adapt the energy transmitted to said casing (20A, 20B) as a function of electrical constraints of said casing (20A, 20B) or of an apparatus (10) contained in said casing (20A, 20B).

4. The case according to claim 1, comprising means (33) for detecting the presence of said casing (20A, 20B), and means for controlling said wireless energy-transmitter means (35) as a function of said presence.

5. The case according to claim 1, comprising means (33) for determining a level of energy available in said casing (20A, 20B), and means for controlling said wireless energy-transmitter means (35) as a function of said level.

6. The case according to claim 1, wherein said wireless transmitter means (35) are positioned so as to co-operate with the wireless receiver means (25) of said casing, for a plurality of positions of said casing (20A, 20B) in the case (30).

7. The case according to claim 1, wherein said holder means (37) comprise guide means matching the shape of said casing (20A, 20B).

8. The case according to claim 1, wherein said energy storage means (32) are of a kind different from the battery (12) of said apparatus (10).

9. The case according to claim 1, wherein said casing (20A, 20B) includes means (23) for adapting the energy received from said piece of equipment (30) as a function of electrical constraints of said battery (12) or of said apparatus (10).

10. The case according to claim 9, wherein said casing (20A, 20B) includes a polarization rectifier (23) adapted to generate electricity of polarity that is compatible with the polarity of said connector (11).

11. The case according to claim 1, wherein said casing (20A, 20B) includes means (27) enabling it to be fastened to said piece of equipment (30) in at least one predetermined position while mobile.

12. The case according to claim 1, wherein said casing (20A, 20B) comprises protection means (23) adapted to avoid the battery (12) of said apparatus (10) discharging or overcharging.

13. The case according to claim 1, wherein said casing (20A, 20B) includes a battery (24) adapted to feed the battery (12) of said apparatus (10) via its connector (11).

14. The case according to claim 1, wherein said casing (20A, 20B) includes a solar cell adapted to recharge the battery (24) of said casing (20A, 20B) and/or the battery (12) of said apparatus (10) via its connector (11).
